(19) United States
(12) Patent Application Publication
(10) Pub. No.: US 2004/0203976 A1
(43) Pub. Date: Oct. 14, 2004

(54) Power management for nodes coupled to a communication link

(76) Inventors: Vivek G. Gupta, Portland, OR (US); Ernest E. Woodward, Chandler, AZ (US)

Correspondence Address: Fred G. Pruner, Jr., TROP, PRUNER & HU, P.C., STE 100, 8554 KATY FWY., HOUSTON, TX, 77024-1841, US

(21) Appl. No.: 10/331,786

(22) Filed: Dec. 30, 2002

(51) Int. Cl. H04Q 7/20; H04B 1/38

(52) U.S. Cl. 455/517; 455/556.1

(57) ABSTRACT

A system includes a communication link, a first node and a second node. The first link communicates a request over the communication link to the second node indicating a suspended state of operation of the first node. In response to this communication of the request, the first node is placed in a suspended state of operation.

### BACKGROUND

The invention generally relates to power management for nodes that are coupled to a communication link.

A conventional portable computing or communication device, such as a cellular telephone or a personal digital assistant (PDA) (as examples), may include an application subsystem and a communication subsystem. As an example, the application subsystem may be used for purposes of forming features and capabilities that are visible or used by a user of the portable device. The communication subsystem may serve the purpose of communicating with other networks, such as cellular networks, wireless local area networks, etc.

Quite often, a circuit of the application subsystem or communication subsystem may become idle. For example, a user of the portable device may be playing a game that involves the application subsystem and does not involve the communication subsystem; and thus, some or all circuitry of the communication subsystem may become idle. In general it may be desirable to place an idle circuit into a lower power consumption state to conserve power resources (energy stored in a battery for example) of the portable device. However, transitioning a particular circuit into a lower power state may present challenges due to the presence of other circuits (of the device) that communicate with the circuit to be powered down. Similar challenges may exist when transitioning this circuit from a lower power state to a higher power state.

Thus, there is a continuing need for better ways to power down and/or power up a circuit that communicates with other circuits in a particular system.

### BRIEF DESCRIPTION OF THE DRAWING

FIG. 1 is a block diagram of a portable computing or communication device according to an embodiment of the invention.

FIG. 2 is a block diagram of an interface to a communication link of the system of FIG. 1 according to an embodiment of the invention.

FIG. 3 is a schematic diagram illustrating nodes coupled to a communication link according to an embodiment of the invention.

FIG. 4 is a flow diagram depicting a technique to initialize a node that is coupled to a communication link according an embodiment of the invention.

FIG. 5 is a flow diagram depicting a technique to transition a node from a state of operation and to a suspended state of operation according to an embodiment of the invention.

FIG. 6 is a flow diagram depicting a technique to transition a node from a suspended state of operation to a normal state according to an embodiment of the invention.

### DETAILED DESCRIPTION

An embodiment of a portable computing or communication device (called a “portable device 10” herein) includes an application subsystem 20 and a communication subsystem 40 that communicate via a communication link 50 of the device 10. A particular circuit (of either subsystem 20, 40) that communicates over the communication link 50 may become idle, and thus it may be desirable to transition this circuit from a normal state of operation in which the circuit is fully powered up to a lower power, suspended state of operation in which the circuit retains configuration information but in general no longer is functional. As described herein, in accordance with the invention, before transitioning between power states (such as the normal and suspended states of operation (as an example)), the circuit communicates with the other circuit(s) over the communication link 50 to synchronize the upcoming power state transition with these other circuit(s). This power state transition may not only be a transition from a normal state of operation to a suspended state of operation but may also be a transition from the suspended state of operation to the normal state of operation, a transition from a completely powered down state to the normal state of operation, a transition from the normal state of operation to the powered down state, etc.

As a more specific example, the portable device 10 may be a one-way pager, a two-way pager, a personal communication system (PCS), a personal digital assistant (PDA), a cellular telephone, a portable computer, etc. The application subsystem 20 provides features and capabilities that are visible and/or used by a user of the portable device 10. For example, the application subsystem 20 may be used for purposes of email, calendaring, audio, video, gaming, etc. The communication subsystem 40 may be used for purposes of providing wireless and/or wired communication with other networks, such as cellular networks, wireless local area networks, etc.

For the case in which the portable device 10 is a cellular telephone, the application subsystem 20 may provide an interface to the user of the cellular telephone and thus, provide a keypad 22 which the user may use to enter instructions and telephone numbers into the cellular telephone; a display 24 for displaying command options, caller information, telephone numbers, etc.; and a microphone 26 for sensing commands and/or voice data from the user. The microphone 26 thus, may provide an analog signal indicative of a voice signal, and this analog signal may be converted into a digital format by an analog-to-digital converter (ADC) 32. The digital data from the ADC 32, in turn, is provided to an application processor 34 of the application subsystem 20. Likewise, data from the keypad 22 may also be provided to the application processor 34. Graphical data may be provided by the application processor 34 to the display 24 for viewing by the user of the cellular telephone.

Among the other features of the application subsystem 20, the subsystem 20 may include a speaker 28 that receives an analog signal from a digital-to-analog converter (DAC) 30 that, in turn, receives digital data from the application processor 34. For example, the speaker 28 may be used to provide an audible ringing signal to the user, for the case in which the device 10 is a cellular telephone, as well as provide an audio stream for audio data that is provided by a cellular network, for example.

The application subsystem 20 may also include a memory 36. As an example, this memory 36 may be a dynamic random access memory (DRAM) or a flash memory, as just a few examples. The memory 36 is coupled to the application processor 34 for purposes of storing data, operating system code, application code, etc. that is executed by the application processor 34. As a more specific example, in some embodiments of the invention, the memory 36 may store instruction code 31 that is executed by the application processor 34 for purposes of powering up and powering down circuits of the application subsystem 20, as further described below. The application subsystem 20 may also include an interface 33 for purposes of establishing a communication bridge between the communication link 50 and circuitry of the application subsystem 20.

In some embodiments of the invention, the portable device 10 may include multiple communication subsystems, and in some embodiments of the invention, the portable device 10 may include multiple nodes (further described below) that are coupled to the communication link 50.

In some embodiments of the invention, the communication subsystem 40 includes a baseband processor 42 that establishes the particular communication standard for the device 10. For example, if the device 10 is a cellular telephone, the baseband processor 42 may establish a code division multiple access (CDMA) cellular radiotelephone communication system, or a wide-band CDMA (W-CDMA) radiotelephone communication system, as just a few examples. The W-CDMA specifically has been proposed as a solution to third generation (“3G”) by the European Telecommunications Standards Institute (ETSI) as their proposal to the International Telecommunication Union (ITU) for International Mobile Telecommunications (IMT)-2000 for Future Public Land Mobile Telecommunications Systems (FPLMTS).

The baseband processor 42 is coupled to a radio frequency/intermediate frequency (RF/IF) interface 48 that forms an analog interface for communicating with an antenna 49 of the device 10. A voltage controlled oscillator (VCO) 46 is coupled to the RF/IF interface 48 to provide signals having the appropriate frequencies for modulation and demodulation, and the baseband processor 42 controls the VCO 46 to regulate these frequencies, in some embodiments of the invention.

Among the other features of the communication subsystem 40, in some embodiments of the invention, the subsystem 40 may include a memory 44 (a DRAM memory or a flash memory, as a few examples) that is coupled to the baseband processor 42. The memory 44 may store program instructions and/or data. For example, in some embodiments of the invention, the memory 44 stores program code 41 for routines to synchronize the power management features of the communication subsystem 40 with respect to the communication link 50.

The processor 34 or 42 may include one or more microprocessors, such as a Pentium® microprocessor, for example. In some embodiments of the invention, the baseband processor 42 may be a digital signal processing (DSP) engine. Other and different processors may be used for the application 34 and baseband 42 processors.

In some embodiments of the invention, each subsystem 20, 40 performs techniques to synchronize the powering down of circuitry that is coupled to the communication link 50. Before these techniques are discussed below, a general overview of the interfaces 33 and 43, as well as the concept of “nodes” in relation to the communication link 50 are discussed below.

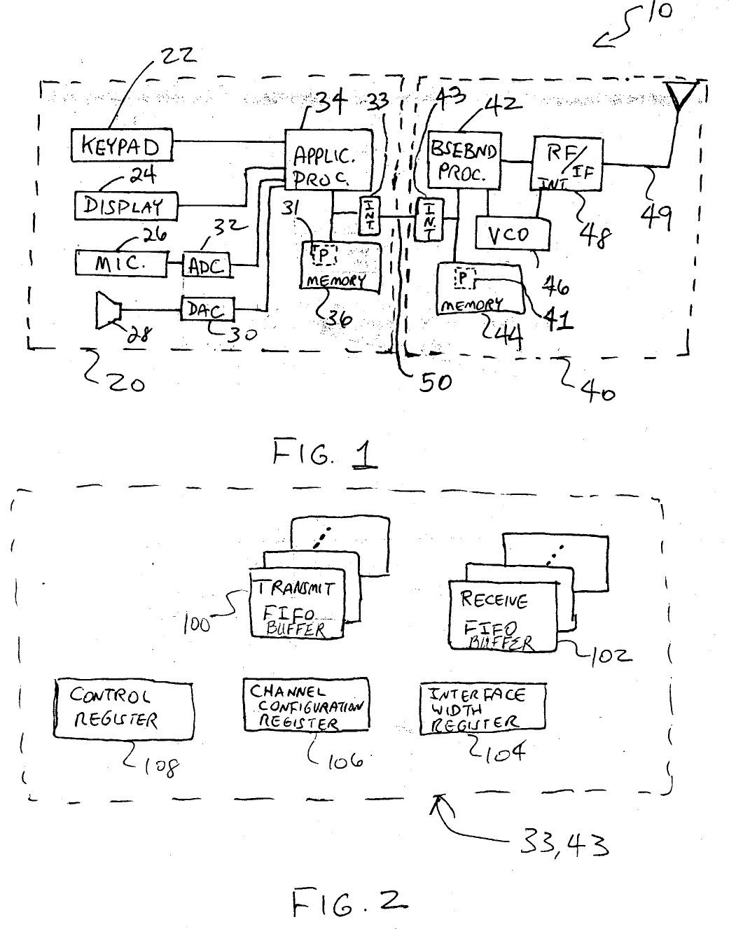

In some embodiments of the invention, each interface 33 or 43 has a similar structure that is generally depicted in FIG. 2. This structure includes transmit first-in-first-out (FIFO) memory buffers 100 for purposes of storing packet data to be communicated over the communication link 50. This data may be stored in the transmit FIFO memory buffers 100 by, for example, circuitry (such as the application processor 34) of the application subsystem 20 (for the interface 33) or circuitry (such as the baseband processor 42) of the communication subsystem 40 (for the interface 43). The interface 33, 43 also includes receive FIFO memory buffers 102 for purposes of storing packet data that is received from the communication link 50. This data may be communicated from the receive memory buffers 102 to, for example, circuitry (such as the application processor 34) of the application subsystem 20 (for the interface 33) or circuitry (such as the baseband processor 42) of the communication subsystem 40 (for the interface 43).

During normal operation of the communication link 50, data may be communicated between the interfaces 33 and 43 via one of several channels that are established over the communication link 50. In some embodiments of the invention, each interface 33, 43 may set up a particular DMA transfer over a particular DMA channel using selected interrupts.

In some embodiments of the invention, the communication link 50 has configurable hardware options that describe the interface's physical connection to the link 50. In particular, in some embodiments of the invention, each interface 33, 43 includes an interface width register 104 that selects the interface width (in terms of bits or bytes) for both incoming and outgoing data from the interface 33, 43. The interface 33, 43 also includes, in some embodiments of the invention, a channel configuration register 106 that indicates the channels used by the interface 33, 43 in communicating over the communication link 50. In some embodiments of the invention, the configuration register 106 indicates a particular channel, such as Channel0, that is used for purposes of communicating information to synchronize the power management, as further described below. The interface 33, 43 may also include a control register 108 that enables the outbound communication of data from the interface 33, 43. Other variations for the interface 33, 43 are possible, in other embodiments of the invention.

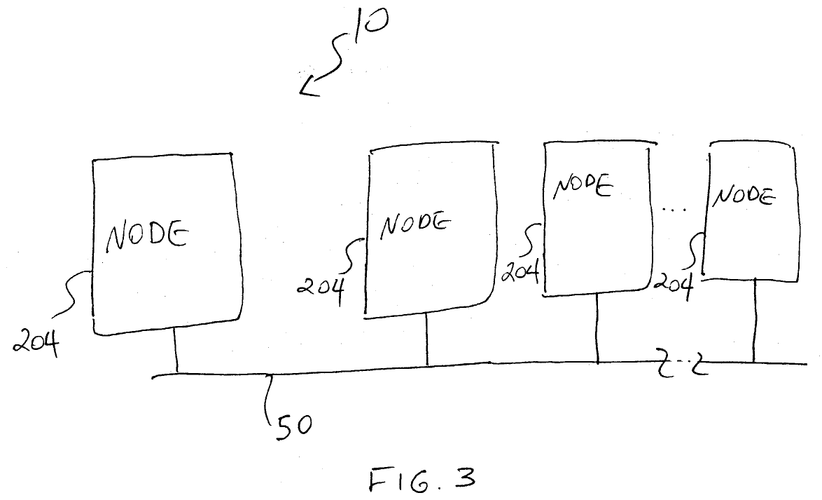

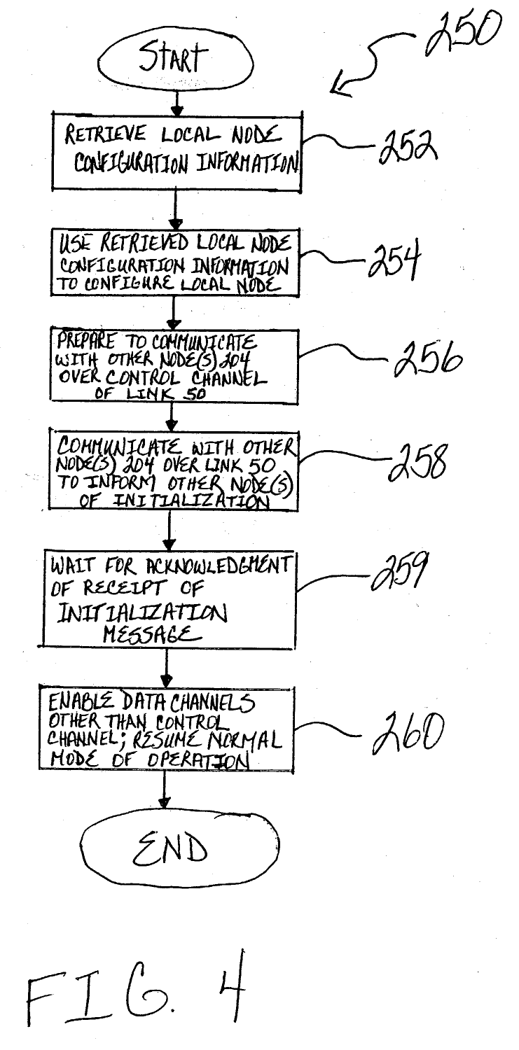

Referring to FIG. 3, in some embodiments of the invention, in relation to the communication link 50, the device 10 may be viewed as including nodes 204 that are each coupled to the communication link 50. Simply stated, a particular node 204 may represent any circuit or portion of a component within the portable device 10. For example, in some embodiments of the invention, the application subsystem 20 (FIG. 1) may form one particular node 204 and the communication subsystem 40 may form another node 204. The portable communication device 10 may include additional nodes 204 outside of either subsystem 20 or 40. It is noted that the application subsystem 20 may form more than one node that is connected to the communication link 50, and similarly, the communication subsystem 40 may form more than one node 204 that is coupled to the communication link 50. For example, in some embodiments of the invention, a particular node 204 may represent a portion of the application processor 34, a portion of the display 24, a portion of the baseband processor 42, etc. For purposes of simplifying the discussion herein, regardless of the portion of the particular subsystem 20, 40 that forms a particular node 204, it is assumed that each node 204 includes either the interface 33 or the interface 43.

In some embodiments of the invention, the phrase “normal state of operation” means an operational state in which the node 204 has been fully powered up and initialized and is not currently in a suspended state of operation, although the scope of the invention is not limited in this respect. In some embodiments of the invention, the phrase “suspended state of operation” means that the node 204 is currently idle in a power conservation state that is associated with a lower power consumption than when the node 204 is fully powered up, although the scope of the invention is not limited in this respect; and thus, in this state, the node 204 has been powered down to a certain degree. In some embodiments of the invention, in the suspended state of operation, the node 204 retains its configuration information for the communication link 50, in contrast to the powered down state in which all power is removed from the node 204 and/or the power to the node 204 is reduced to the extent that the configuration information is lost or is otherwise unreliable.

Referring to FIG. 4, in some embodiments of the invention, during its initialization (i.e., during its transition from a powered down state to a normal state of operation) a particular node 204 may perform a technique 250 for purposes of synchronizing this initialization with all of the other node 204 or nodes 204 that are coupled to the communication link 50. As a more specific example, for the case of a particular node 204 including the application processor 34, the application processor 34 may execute instructions, such as the program code 31 (that is stored in the memory 36 (FIG. 1) for example), for purposes of causing the node 204 to perform the technique 250. As another example, a particular node 204 may include the baseband processor 42, and in this scenario, the baseband processor 42 may execute the instructions, such as the program code 41 (that are stored in the memory 44 (FIG. 1) for example), for purposes of performing the technique 250. Many other variations are possible.

In the technique 250, the node 204 retrieves (block 252) the local node configuration information. As a more specific example, in some embodiments of the invention, this local node configuration information may be default configuration information based on a selected system configuration by the manufacturer of the portable device 10, for example.

Next in the technique 250, the node 204 uses the retrieved local node configuration information to configure the local node 204, as depicted in block 254. In some embodiments of the invention, the configuration information specifies default interface widths for inbound and outbound communications over the communication link 50, as well as channels of the link 50 to be used for communicating with the node 204. Thus, in some embodiments of the invention, configuring the node 204 may involve writing the particular bits or bytes in the interface width register 104 (FIG. 2) to set up the widths of inbound and outbound communications over the communication link 50; writing the appropriate bits or bytes to the channel configuration register 106 to set up selected channels for communication across the communication link 50; and enabling outbound communication from the node 204 by setting the appropriate bit in the control register 108. Furthermore, in some embodiments of the invention, configuring the local node 204 may include delaying for a predetermined time (100 microseconds, for example), clearing the receive FIFO memory buffers 102 and clearing the transmit FIFO memory buffers 100. Other techniques may be used, in other embodiments of the invention, for configuring the node 204 for the normal state of operation.

Next in the technique 250, in some embodiments of the invention, the node 204 prepares to communicate (block 256) with the other node(s) 204 over the pre-selected control channel (Channel0, for example) of the communication link 50. This may involve setting up appropriate DMA parameters and interrupts for the appropriate data packet transfers over the control channel. The transfers are set up only on this control channel at this point, in some embodiments of the invention, because each node 204 is unaware of the channel count for the other node(s) 204. In some embodiments of the invention, the nodes 204 may also communicate for purposes of agreeing on some other configuration parameters for purposes of setting up initial communication, such as the default width of the communication link 50, the frequency of the communication link 50, etc.

The node 204 subsequently communicates with the other node(s) 204 over the communication link 50 to inform the other node(s) 204 of its initialization, as depicted in block 258. Next, the node 204 waits for acknowledgment of receipt of the initialization message, as depicted in block 259. As a more specific example, in some embodiments of the invention, the blocks 258 and 259 may form a software handshake, as can be appreciated by one skilled in the art.

Lastly, in the technique 250, the node 204 enables (block 260) data channels other than the control channel and resumes a normal state of operation. The communication to the other node(s) 204 of the initialization of the transmitting node 204 causes these other node(s) 204 to initialize themselves.

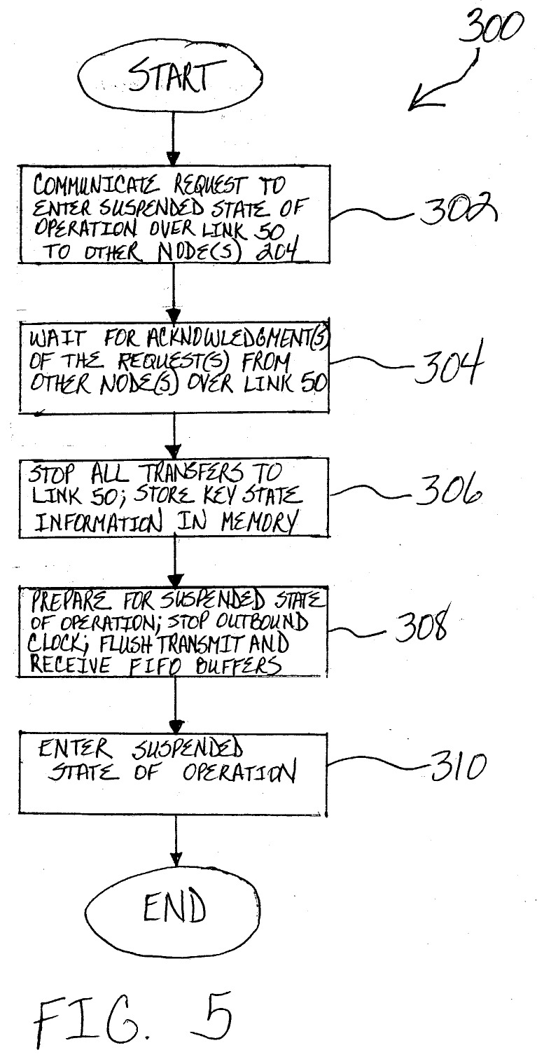

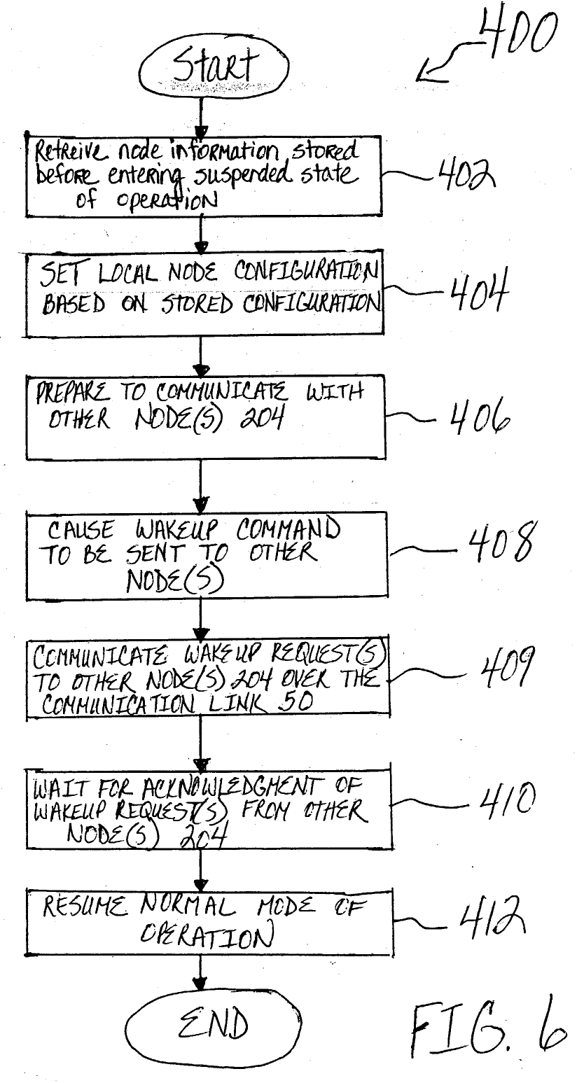

Referring to FIG. 5, in some embodiments of the invention, the node 204 performs a technique 300 when the node 204 transitions from a normal state of operation to a suspended state of operation. In some embodiments of the invention, the node 204 executes a routine leading to the technique 300 in response to an operating system (OS) of the node 204 calling a power suspension routine.

In the technique 300, the node 204 communicates (block 302) a request over the communication link 50 to enter the suspended state of operation to the other node(s) 204. The node 204 then waits for acknowledgment(s) of the requests from other node(s) over the communication link 50, as depicted in block 304. In some embodiments of the invention, the blocks 302 and 304 may be accomplished via a software handshake, as can be appreciated by one skilled in the art. Next in the technique 300, the node 204 stops all transfers to the communication link 50 and stores key state information in a memory of the node 204, as depicted in block 306. For example, in some embodiments of the invention, the node 204 may read the current values from the registers 104 and 106 (FIG. 2) and store these values in local memory, such as the memory 36 (for a node 204 associated with the application subsystem 20) or the memory 44 (for a node 204 associated with the communication subsystem 40). As a more specific example, if the particular node 204 includes part of the application subsystem 20, then the values from the registers 104 and 106 may be stored in the memory 36, for example. Other configuration information and/or other memory may be used.

Pursuant to the technique 300, the node 204 subsequently prepares for the suspended state of operation, stops the outbound clock signal that is provided by the node 204 to the communication line 50 and flushes the buffers of the node 204, as depicted in block 308. As a more specific example, in some embodiments of the invention, the node 204 for the suspended state of operation may include flushing the transmit 100 and receive 102 FIFO memory buffers.

Lastly, in the technique 300, the node 204 enters the suspended state of operation, as depicted in block 310. As a more specific example, in some embodiments of the invention, the node 204 may return control to the operating system (OS) hardware abstraction layer (HAL) and other components to put the node 204 and the communication link 50 in the suspended state of operation. Other variations are possible.

Referring to FIG. 6, in some embodiments of the invention, a particular node 204 may perform a technique 400 that is depicted in FIG. 6 for purposes of resuming a normal state of operation from a suspended state of operation. In some embodiments of the invention, the technique 400 may be performed in response to the execution of a power resumption routine by an operating system (OS) of the node 204. However, other variations are possible for initiating the execution of the technique 400.

In some embodiments of the invention, the technique 400 includes retrieving node configuration information that was stored before the node 204 entered the suspended state of operation, as depicted in block 402. Alternatively, in some embodiments of the invention, this node configuration information may be computed on wakeup from the suspended mode, and hence, it may not be required to save the configuration information as part of the suspension procedure.

Subsequently in the technique 400, the node 204 sets (block 404) the local node configuration based on the stored configuration. This local node configuration may be similar to block 254 in the technique 250 (see FIG. 4). In this manner, in some embodiments of the invention, the appropriate values may be written to the interface width register 104 and the channel configuration register 106 for purposes of configuring the inbound and outbound data width and the channels to be used for communication with the node 204. Other variations are possible.

Subsequently, the technique 400 includes preparing (block 406) to communicate with the other node(s) 204 on all enabled data channels. After this preparation, the technique 400 includes causing a wakeup command to be sensed to the other node(s) 204, as depicted in block 408. A more specific example, in some embodiments of the invention, the wakeup command may be transmitted over a predetermined channel such that hardware of the node 204 detects this wakeup command to wakeup the associated node 204. In some embodiments of the invention, this is a pure hardware event on the node 204, causing the entire node 204 to wakeup if asleep and not just the communication link 50, in some embodiments of the invention. The software, however, on the node 204 may not receive this wakeup command, in some embodiments of the invention. This is similar to the behavior when a remote chip is awakened by other mechanisms like the press of a button, etc.

Subsequent to the hardware resuming from the suspended state into the normal state of operation, the technique 400 includes communicating (block 409) wakeup request(s) to the other node(s) 204 over the communication link 50. Unlike the previous wakeup command, this request may be a software request (in some embodiments of the invention), and subsequently, the node 204 waits (block 410) for acknowledgment of the wakeup request(s) from the other node(s) 204. In this manner, the blocks 408 and 410 may be a software handshake, as can be appreciated by one skilled in the art. Alternatively, in some embodiments of the invention, blocks 408 and 410 may be accomplished via one or more signals that are communicated between nodes 204 by hardware of the nodes 204. Thus, in some embodiments of the invention, hardware signaling may be used. Lastly in the technique 400, the node 204 resumes the normal mode of operation, as depicted in block 412.

Thus, the techniques described herein provide a deterministic and reliable way to set common node configuration parameters for each node in a multi-node environment. Furthermore, the techniques described herein provide a deterministic and reliable way to handshake between nodes and commence data transfer in a multi-node environment. Furthermore, the techniques described herein provide a reliable way to synchronize between nodes and prepare a communication link to go into a suspended state of operation and provide a reliable way to synchronize between multiple nodes and resume a normal mode of operation when the node comes out of the suspended state of operation. Other and different advantages are possible in other embodiments of the invention.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

What is claimed is:

1. A method comprising:
coupling a first node and a second node to a communication link;
communicating a request over the link from the first node to the second node indicating a suspended state of operation of the first node; and
in response to the communication of the request, placing the first node in the suspended state of operation.

2. The method of claim 1, further comprising:
in response to acknowledgment of receipt of the request by the second node, placing the first node in the suspended state of operation.

3. The method of claim 1, wherein placing the first node in the suspended state of operation comprises:
stopping communication between the first node and the link.

4. The method of claim 1, wherein placing the first node in the suspended state of operation comprises:
saving state information associated with communication over the link.

5. The method of claim 1, wherein placing the first node in the suspended state of operation comprises:
halting an outbound clock signal associated with communication over the link.

6. The method of claim 1, wherein placing the first node in the suspended state of operation comprises:
flushing buffers of the first node.

7. A method comprising:
coupling a first node and a second node to a link;
transitioning the first node from a suspended state of operation; and
in response to the transitioning, communicating with the second node over the link to transition the second node from a suspended state of operation.

8. The method of claim 7, wherein the communicating comprises:
communicating a software request over the link to the second node to transition the second node from the suspended state of operation.

9. The method of claim 7, wherein the communicating comprises:
communicating a hardware request over the link to the second node to transition the second node from the suspended state of operation.

10. The method of claim 7, wherein the communicating comprises:
communicating a software request over the link to the second node to transition the second node from the suspended state of operation; and
communicating a hardware request over the link to the second node to transition the second node from the suspended state of operation.

11. The method of claim 7, further comprising:
resetting a configuration state of the first node to a state existing before the first node transitioned from a normal state of operation into the suspended state of operation.

12. A method comprising:
coupling a first node and a second node to a link;
in response to initialization of the first node, communicating over the link with the second node to determine whether the second node is initialized; and
in response to the determination, commencing normal data communication with the second node.

13. The method of claim 12, further comprising:
in response to acknowledgment by the second node of the communication to determine whether the second node is initialized, commencing normal data communication with the second node.

14. The method of claim 12, wherein the communicating over the link occurs over a predefined channel selected prior to initialization of the first node.

15. The method of claim 12, further comprising:
initializing the first node with previously stored configuration information in response to the initialization.

16. A system comprising:
a communication link;
a first node coupled to the communication link; and
a second node coupled to the communicate link,
wherein the first node communicates a request over the communication link to indicate a suspended state of operation of the first node and in response to the communication of the request, the first node enters the suspended state of operation.

17. The system of claim 16, further comprising:
in response to acknowledgment of receipt of the request by the second node, placing the first node in the suspended state of operation.

18. The system of claim 16, wherein placing the first node in the suspended state of operation comprises:
stopping communication between the first node and the link.

19. The system of claim 16, wherein placing the first node in the suspended state of operation comprises:
saving state information associated with communication over the link.

20. The system of claim 16, wherein placing the first node in the suspended state of operation comprises:
halting an outbound clock signal associated with communication over the link.

21. The system of claim 16, wherein placing the first node in the suspended state of operation comprises:
flushing buffers of the first node.

22. A system comprising:
a communication link;
a first node coupled to the communication link; and
a second node coupled to the communication link,
wherein in response to the first node transitioning from a suspended state of operation, the first node communicates with the second node over the communication link to transition the second node from a suspended state of operation.

23. The system of claim 22, wherein the first node is reset to a state existing before the first node entered the suspended state of operation in response to the transition from the suspended state of operation.

24. The system of claim 22, wherein the communicating comprises:
communicating a software request over the link to the second node to transition the second node from the suspended state of operation.

25. The system of claim 22, wherein the communicating comprises:
communicating a hardware request over the link to the second node to transition the second node from the suspended state of operation.

26. A system comprising:
a communication link;
a first node coupled to the communication link; and
a second node coupled to the communication link,
wherein in response to the initialization of the first node, the first node communicates over the communication link with the second node to determine whether the second node is initialized and in response to the determination, the first node commences normal data communication with the second node.

27. The system of claim 26, further comprising:
in response to acknowledgment by the second node of the communication to determine whether the second node is initialized, commencing normal data communication with the second node.

28. The system of claim 26, wherein the communicating over the link occurs over a predefined channel selected prior to initialization of the first node.

29. The system of claim 26, further comprising:
initializing the first node with previously stored configuration information in response to the initialization.

30. A system comprising:
a communication link;
a flash memory coupled to the communication link to store data for communication over the communication link;
a first node coupled to the communication link; and
a second node coupled to the communicate link,
wherein the first node communicates a request over the communication link to indicate a suspended state of operation of the first node and in response to the communication of the request, the first node enters the suspended state of operation.

31. The system of claim 30, wherein the flash memory is part of at least one of the first node and the second node.

32. An article comprising a computer readable storage medium storing instructions to cause a processor to:
communicate a request over a link from a first node to a second node indicating a suspended state of operation of the first node; and
in response to the communication of the request, place the first node in the suspended state of operation.

33. The article of claim 32, the storage medium storing instructions to cause the processor to:
in response to acknowledgment of receipt of the request by the second node, place the first node in the suspended state of operation.

34. The article of claim 32, the storage medium storing instructions to cause the processor to:
stop communication between the first node and the link.

35. The article of claim 32, the storage medium storing instructions to cause the processor to:
save state information associated with communication over the link.
